(19) United States
(12) Patent Application Publication
(10) Pub. No.: US 2002/0107926 A1
(43) Pub. Date: Aug. 8, 2002

(54) System and method for routing an electronic mail to a best qualified recipient by using machine learning

(76) Inventor: Bogju Lee, Daejeon (KR)

Correspondence Address: David A. Einhorn, Esq., Anderson Kill & Olick, P.C., 1251 Avenue of the Americas, New York, NY, 10020, US

(21) Appl. No.: 09/981,990

(22) Filed: Oct. 17, 2001

(30) Foreign Application Priority Data
Nov. 29, 2000 (KR) 2000-71732

(51) Int. Cl. G06F 15/16

(52) U.S. Cl. 709/206; 706/52; 709/245

(57) ABSTRACT

A system for delivering an e-mail with an unspecified recipient, which is received via a mail server, to a best qualified recipient includes a learning agent and a classifying agent. The learning agent builds learning models corresponding to recipients from e-mails stored in the mail server by using a machine learning algorithm. The classifying agent classifies a learning model corresponding to a best qualified recipient, when a new e-mail is received, and delivers the new e-mail to the best qualified recipient.

### FIELD OF THE INVENTION

The present invention relates to an electronic mail system and method; and, more particularly, to an electronic mail (e-mail) system and method for forwarding an e-mail received in data network to a best qualified recipient by using machine learning.

### DESCRIPTION OF THE PRIOR ART

Recently, communications via electronic mail resources are becoming increasingly popular. One such electronic mail resource is generally known as e-mail. E-mail provides a quick and convenient way for computer users to communicate. E-mail has recently become one of the most commonly used communications tools in business. As more and more homes are getting connected to the Internet, it certainly will become an important communications tool for homes also.

In general, a user to whom a message is sent is referred to as an addressee or recipient of the message and a user who sends the message is referred to as a sender. In the simplest case, an e-mail makes a delivery of a text-based message from a sending computer to one or more recipient computers. The sending and the recipient computers are connected to a data network. Typically, the message is temporarily stored in a mail server of the data network. The recipient (user) can retrieve the stored message at his/her convenience.

This communication is initiated by the message sender who composes the message by using a text editing program, provides an e-mail address of the intended recipient, and often provides an indication of the content (subject matter) of the message by providing text in a “subject” field. By using well-known technology, this composed message is then sent to the recipient's address.

The sender who transmits the composed message must know the correct recipient's e-mail address because the mechanics of the Internet require an exact e-mail address. However, it is difficult for the sender to correctly know all the corresponding associated recipient's e-mail addresses as an organization, such as a company or a division within a company, expands and the number of users increases.

In this case, the sender may attempt to transmit the e-mail message to recipients having e-mail addresses similar to that of the intended recipient, or to all recipients. However, this attempt not only increases unwanted messages for the unintended recipients but also increases e-mail traffic, which in turn deteriorates the efficiency of the communications system, while the real intended recipient may not receive the e-mail message at all. Therefore, there is a need for an e-mail system capable of forwarding the e-mail to the real intended recipient even though the e-mail sender does not know the correct recipient's e-mail address.

### SUMMARY OF THE INVENTION

It is, therefore, an object of the invention to provide an e-mail system capable of forwarding an e-mail to an intended recipient even though an e-mail sender does not know a correct e-mail address of the intended recipient.

In accordance with the present invention, there is provided a method for forwarding an e-mail with an unspecified recipient, which is received via a mail server, to a best qualified recipient, comprising steps of:

building learning models corresponding to recipients from e-mails stored in a mail server using a machine learning algorithm; and

classifying, when a new e-mail is received, a learning model corresponding to a best qualified recipient and delivering the new e-mail to the best qualified recipient.

### BRIEF DESCRIPTION OF THE DRAWINGS

The above and other objects and features of the present invention will become apparent from the following description of preferred embodiments given in conjunction with the accompanying drawings, in which:

FIG. 1 shows a block diagram for an electronic mail (e-mail) system in accordance with a preferred embodiment of the present invention;

FIG. 2 illustrates a flow chart for describing a model building procedure conducted by a learning agent 220 shown in FIG. 1;

FIG. 3 represents an exemplary decision tree generated by a tree generating algorithm; and

FIG. 4 shows a flow chart for processing a newly received e-mail by a classifying agent 260 shown in FIG. 1.

### DETAILED DESCRIPTION OF THE PREFERRED EMBODIMENTS

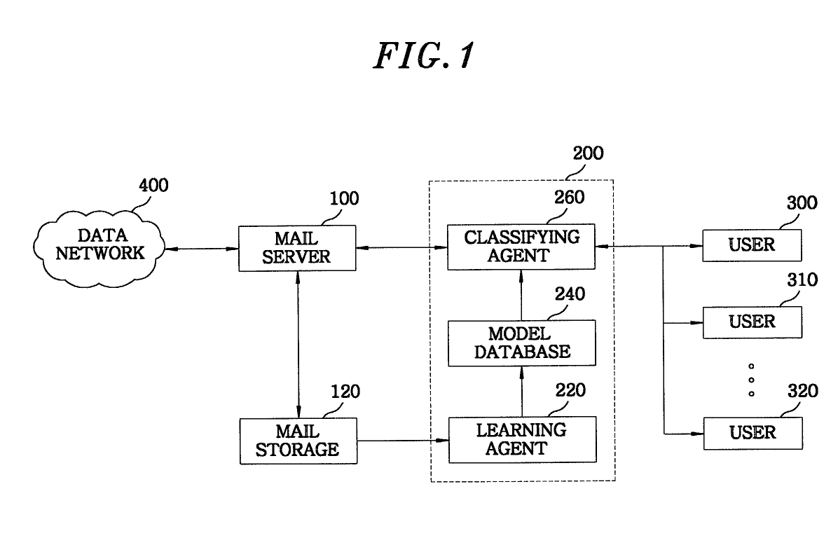

Referring now to FIG. 1, there is illustrated a block diagram of an electronic mail (e-mail) processing system in accordance with a preferred embodiment of the present invention. The e-mail processing system includes a mail server 100, a mail storage 120, a TWIMC (To Whom It May Concern) system 200, recipients, i.e., users, 300 to 320 and data network 400. The mail storage 120 and the TWIMC system 200 can be incorporated in the mail server 100. The data network 400 may be, e.g., the Internet or a groupware system.

The mail server 100 processes e-mails transmitted from a sender or received by a recipient through the data network 400, which is incorporated into a groupware system aiming for supporting a group work done by a plurality of users or a general e-mail system using the internet. The received or the transmitted e-mails are temporarily stored at the mail storage 120.

The TWIMC 200 has a learning agent 220, a model database 240 and a classifying agent 260. The TWIMC 200 forwards an e-mail to a best-qualified recipient based on a result of a content analysis thereof. The content analysis of the e-mail is done by the classifying agent 260. Details of forwarding function of the e-mail to the best qualified recipient will be described hereinafter.

The learning agent 220 in the TWIMC system 200 reads the e-mail from the mail storage 120 and executes a machine learning algorithm well known in the artificial intelligent field, e.g., ID3 or C4.5, to thereby generate models on recipients and then store them in the model database 220.

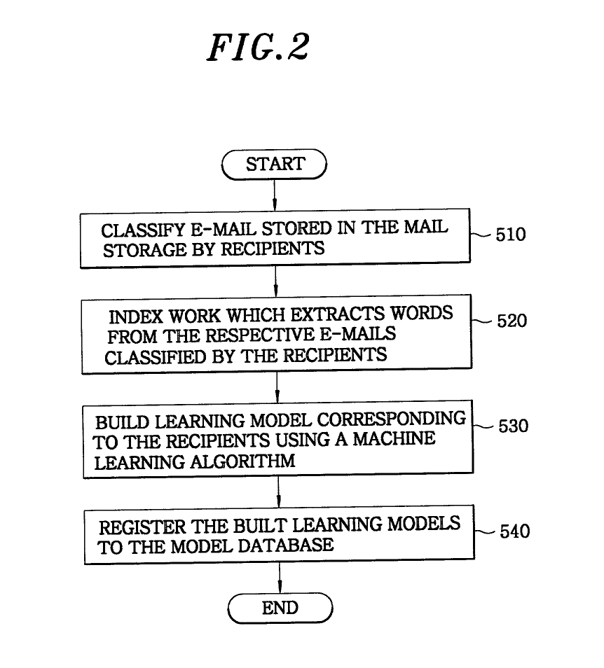

Referring to FIG. 2, there is illustrated a flow chart for describing a model building procedure by the learning agent 220 shown in FIG. 1. The learning agent 220 classifies e-mails stored in the mail storage 120 by recipients, i.e., mail accounts, at step 510. And then, the learning agent 220 performs an indexing work that extracts words from the respective e-mails classified by the mail accounts, at step 520. Next, the learning agent 220 builds learning models on the recipients by using a well-known machine learning algorithm, e.g., ID3 or C4.5., at step 530. In case of using the machine learning algorithm ID3, decision trees are used as learning models. The built learning models are registered in the model database 240 at step 540.

As an example, it is assumed that four mails Mail 1 to Mail 4 are stored in the mail storage 120. The learning agent 220 classifies the e-mails by the recipients, e.g., Tom or the like, and then extracts words from the respective mails classified above. Next, the learning agent 220 performs the indexing work by using the extracted words. The result of the indexing work is as follows:

TABLE 1

| | | Build- | Bill | | | | |
|---|---|---|---|---|---|---|---|
| Mail | Recipient | ing | collecting | customer | Bank | account | . . . |
| Mail | Tom | 1 | 1 | 0 | 1 | 1 | . |
| 1 | | | | | | | |
| Mail | Tom | 1 | 1 | 0 | 1 | 0 | . |
| 2 | | | | | | | |
| Mail | Other | 1 | 0 | 1 | 0 | 1 | . |
| 3 | | | | | | | |
| Mail | Other | 1 | 1 | 1 | 1 | 1 | . |
| 4 | | | | | | | |

As shown in table 1, the recipient of the Mail 1 and Mail 2 is registered as Tom and the contents of them are related to a bill collecting in the bank. The recipients of the other mails are not Tom but others. Words extracted from the stored mails Mail 1 to Mail 4 are a building, a bill collecting, a customer, a bank and an account, and the like. If a word is extracted from the contents of the respective mails, “1” is given as the index value of the word. Otherwise, “0” is given as its index value. As a result, in table 1, it can be predicted that Tom is involved in bill collecting at the bank.

In this specification, a training example is presented by a set of attributes and values, and the result is given by a set of an attribute and a value. The cases shown in table 1 will be discussed as a training example. In the table 1, a building, a bill collecting, a customer, a bank and an account are the attributes of the problem, and the recipients are the attributes of the result. The learning agent 220 performs a machine learning for positive examples Mail 1 and Mail 2 of which recipient is Tom and negative examples Mail 3 and Mail 4 of which recipient is not Tom.

The learning result is described by using a decision tree. Each node of the decision tree represents a test. When a new problem is applied to this decision tree, the branches of the decision tree are traced according to the test result until the leaf node, where the solution is described, is reached.

The learning algorithm, e.g., ID3, is used to build the decision tree. The details of ID3 is described in “C4.5: Programs for Machine learning” by Quinlan, J. R., Morgan Kauffman, 1993. In the following, a simplified algorithm will be explained for the exemplary case shown in Table 1. Given a set of non-categorical attributes R, e.g., a building, a bill collecting, a customer, a bank and an account, a categorical attribute C, erg., recipient, and a training data T, e.g., a set of mails, the decision tree is generated as follows:

function ID3

(R: a set of non-categorical attributes,

C: the categorical attribute,

T: a training set) returns a decision tree;

begin

If T is empty, return a single node with value Failure;

If T consists of records with all of a same value for the categorical attribute, return a single node with that value;

If R is empty, then return, as a value, a single node with the most frequent value among the values of the categorical attribute that are found in records of T;

Let A be the word with largest Gain(T,A) among attributes in R;

Let {aⱼ|j=1,2, . . . , m} be the values of attribute A;

Let {Tⱼ|j=1,2, . . . , m} be the subsets of T consisting respectively of records with value aⱼ for attribute A;

Return a tree with root labeled A and arcs labeled a₁,

a₂, . . . , aₘ going respectively to the trees;

ID3(R-{A}, C, T₁), ID3(R-{A}, C, T₂), . . . , ID3(R-{A}, C, Tₘ);

end ID3.

The gain Gain(T,A) is given by Eqs. 1 to 3 as follows:

Gain(T,A)=I(T)−I(T,A) Eq. 1

I(T)=−(p/(p+n)log₂(p/(p+n))+n/(p+n)log₂(n/(p+n))) Eq. 2

I(T,A)=Σi(p,+n,)/(p+n)×I(T₁) Eq. 3

where p and n are the number of positive and negative training data, respectively, pᵢ and nᵢ are the number of positive and negative training data in Tᵢ after divided by Aⱼ.

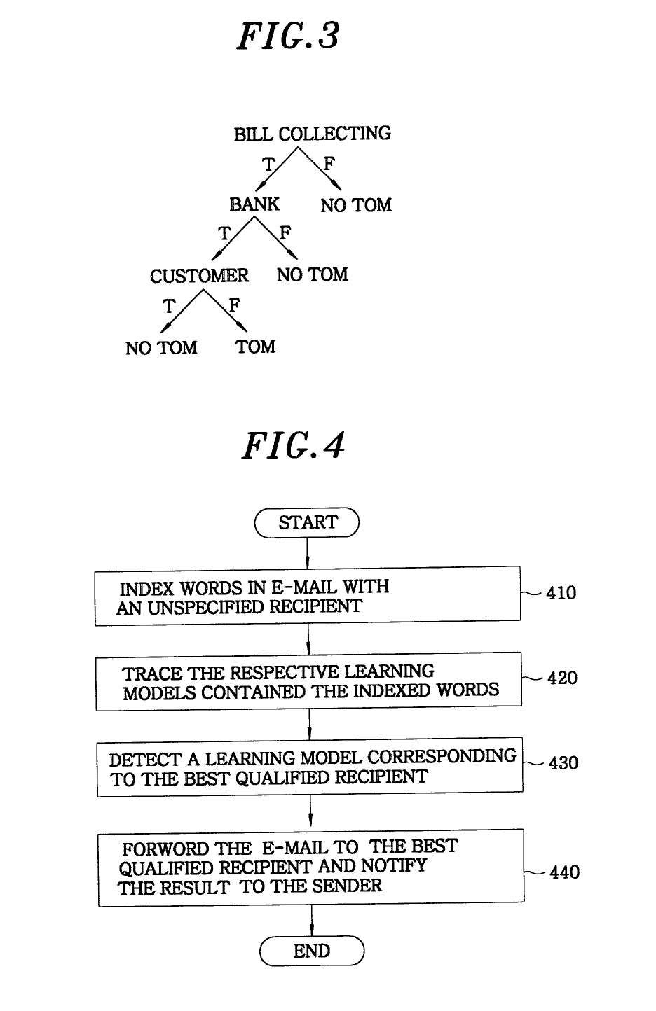

The decision tree generated in the above algorithm is shown in FIG. 3. The decision tree is stored in the model database 240 as a learning model corresponding to a specific recipient.

The classifying agent 260 forwards an e-mail to a best qualified recipient with reference to the learning model when the e-mail is delivered to the mail server 100.

Referring now to FIG. 4, there is provided a flow chart for processing a new e-mail by the classifying agent 260. The classifying agent 260 performs an indexing work for the new e-mail with an unspecified recipient, e.g., TWIMC@icu.ac.kr, and detects words at step 410.

At step 420, the classifying agent 260 traces each learning model, e.g., decision tree, corresponding to the recipient stored in the model database 240 to thereby decide which learning model includes the words indexed from the new e-mail.

At step 430, the classifying agent 260 detects a learning model corresponding to the best qualified recipient based on the result of the tracing at step 420.

At step 440, the classifying agent 260 transmits the new e-mail to the best qualified recipient and then notifies the result to the sender.

For example, it is assumed that a new e-mail with an unspecified recipient, e.g., Mail_{new} TWIMC@icu.ac.kr, is delivered to the mail server 100. The classifying agent 260 indexes the words included in the new e-mail and analyzes the indexed words as follows:

TABLE 2

| | | Bill | | | | | |
|---|---|---|---|---|---|---|---|
| | building | collecting | customer | bank | Account | . | . |
| Mail_{new} | 0 | 1 | 0 | 1 | 1 | . | . |

The classifying agent 260 classifies the new e-mail Mailnew to the left branch of the decision tree in FIG. 3 because the e-mail contains the words, “bill collecting” and “bank”. Next, since the new e-mail Mail_{new} does not contain the word, “customer”, the Mail_{new} is classified as the positive training data. That is, the Mail_{new} is classified to be the same kind with the Mail 1 and the Mail 2 in table 1 and the Mail_{new} is forwarded to Tom. Next, the classifying agent 260 sends the result that the new e-mail Mail_{new} is forwarded to Tom to the sender of the Mail_{new}.

In this way, the new e-mail can be forwarded to the best qualified recipient.

While the invention has been shown and described with respect to the preferred embodiments, it will be understood by those skilled in the art that various changes and modifications may be made without departing from the spirit and scope of the invention as defined in the following claims.

What is claimed is:

1. A method for forwarding an e-mail with an unspecified recipient, which is received via a mail server, to a best qualified recipient, comprising steps of:
building learning models corresponding to recipients from e-mails stored in the mail server by using a machine learning algorithm; and
classifying, when a new e-mail is received, a learning model corresponding to a best qualified recipient and delivering the new e-mail to the best qualified recipient.

2. The method of claim 1, wherein the step of building learning models includes steps of:
dividing the e-mails stored in the mail server according to the recipients of the e-mails;
indexing words included in the e-mails; and
building learning models corresponding to recipients from the indexed words by using the machine learning algorithm.

3. The method of claim 2, wherein the step of classifying a learning model corresponding to a best qualified recipient includes steps of:
tracing the learning models built for the respective recipients by using the words indexed from the new e-mail;
detecting a learning model corresponding to a best qualified recipient; and
delivering the new e-mail to the best qualified recipient.

4. The method of claim 3, wherein the machine learning algorithm is a decision tree algorithm of ID3.

5. The method of claim 4, wherein the learning models are decision trees generated by the decision tree algorithm.

6. A system for delivering an e-mail with an unspecified recipient, which is received via a mail server, to a best qualified recipient, which comprises:
learning agent for building learning models corresponding to recipients from e-mails stored in the mail server by using a machine learning algorithm; and
classifying agent for classifying, when a new e-mail is received, a learning model corresponding to a best qualified recipient and delivering the new e-mail to the best qualified recipient.
